(19) United States
(12) Patent Application Publication
(10) Pub. No.: US 2020/0410387 A1
(43) Pub. Date: Dec. 31, 2020

(54) Minimizing Risk Using Machine Learning Techniques

(71) Applicant: International Business Machines Corporation, Armonk, NY (US)

(72) Inventors: Jeremy R. Fox, Georgetown, TX (US); Chris Kau, Mountain View, CA (US); Liam S. Harpur, Dublin (IE); John Rice, Tramore (AU)

(73) Assignee: International Business Machines Corporation, Armonk, NY (US)

(21) Appl. No.: 16/451,082

(22) Filed: Jun. 25, 2019

(51) Int. Cl. G06N 20/00; G06K 9/62; G06Q 10/04; G06Q 10/06

(52) U.S. Cl. CPC G06N 20/00; G06K 9/6256; G06Q 10/0633; G06Q 10/04; G06K 9/6264

(57) ABSTRACT

Embodiments relate to an intelligent computer platform to utilize machine learning techniques to for task planning optimization. Tasks and task characteristics are collected and tracked over defined temporal segments. Data points and corresponding measurements of the collected and tracked tasks and task characteristics are temporally analyzed. Statistically significant data associated with the tracked tasks are identified in response to the identification of a statistical deviation in the analyzed data points. A path of the tracked tasks is modified to create an optimal delivery path in view of the identified statistical deviation. One or more encoded actions are executed in compliance with the modified path.

### BACKGROUND

The present embodiments relate to an artificial intelligence platform and an optimization methodology for task planning optimization. More specifically, the embodiments relate to employing cognitive computing and machine learning to analyze task movement temporally and implement a corresponding task management optimization.

### SUMMARY

The embodiments include a system, computer program product, and method for cross-compliance risk assessment and optimization.

In one aspect, a computer system is provided with a processing unit and memory for use with an artificial intelligence (AI) computer platform for task planning optimization. The processing unit is operatively coupled to the memory and is in communication with the AI platform and embedded tools, which include a task manager, an analyzer, and a path manager. The task manager functions to collect and track tasks and task characteristics over one or more defined temporal segments. The analyzer functions to temporally analyze one or more data points and corresponding measurements of the collected and tracked tasks and task characteristics, including analyzing the task movement. The analyzer further identifies statistically significant data associated with one or more of the tracked tasks in response to identification of a statistical deviation in one or more of the analyzed data points. The path manager modifies a path of one or more of the tracked tasks to create an optimal delivery path in view of the identified statistical deviation. The processing unit selectively executes one or more enclosed actions in compliance with the modified path.

In another aspect, a computer program device is provided to minimize compliance risk. The program code is executable by a processing unit for task planning optimization. The program code collects and tracks tasks and task characteristics over one or more defined temporal segments. The program code temporally analyzes one or more data points and corresponding measurements of the collected and tracked tasks and task characteristics, including analyzing task movement. Statistically significant data associated with one or more of the tracked tasks are identified in response to the identification of a statistical deviation in one or more of the analyzed data points. The program code modifies a path of one or more of the tracked tasks to create an optimal delivery path in view of the identified statistical deviation. One or more of the encoded actions are selectively executed in compliance with the modified path.

In yet another aspect, a method is provided for task planning optimization. Tasks and task characteristics are collected and tracked over one or more defined temporal segments. One or more data points and corresponding measurements of the collected and tracked tasks and task characteristics are temporally analyzed, including analyzing the task movement. Statistically significant data associated with one or more of the tracked tasks are identified in response to identification of a statistical deviation in one or more of the analyzed data points. A path of one or more of the tracked tasks is modified to create an optimal delivery path in view of the identified statistical deviation. One or more encoded actions are executed in compliance with the modified path.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a system diagram illustrating an artificial intelligence platform computing system.

FIG. 2 depicts a block diagram illustrating the artificial intelligence platform tools, as shown and described in FIG. 1, and their associated application program interfaces.

FIG. 3 depicts a flow chart illustrating functionality of applying machine learning and a corresponding neural network to task management.

FIG. 4 depicts a flow chart illustrating a process for leveraging a time constraint characteristic into the probability assessment.

FIG. 5 depicts a flow chart illustrating a process for leveraging a time constraint characteristic into the probability assessment.

FIG. 6 depicts a block diagram illustrating an example of a computer system/server of a cloud based support system, to implement the system and processes described above with respect to FIGS. 1-5.

FIG. 7 depicts a block diagram illustrating a cloud computer environment.

FIG. 8 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

A project is an undertaking to create a product, service, or result. Projects are commonly comprised of a plurality of tasks, with the tasks representing a piece of work to be undertaken to support the project. Individual tasks relate to items of work to be undertaken. For example, in an office or work-related environment, a task may be an activity required to complete a project or a portion of a project. Tasks may be classified, e.g. task classification, which is directed to a division of tasks by certain facets that identify different aspect, properties, or characteristics of every tasks. Task classification involves analyzing tasks to identify their nature and type, and to determine what facets are common and can be used to create task classes or class categories. Facet-based classification of tasks contributes to effective task planning and control, because it allows defining and grouping tasks by certain facets or attributes. Task classification makes it easier to group tasks into checklists, to-do lists, and projects.

It is understood in the art, that tasks commonly have a corresponding deadline. This is referred to as a task deadline, which is a final desired point in a time length by which the task must be completed. More specifically, it is an end time limit for the task to reach its goals and produce its outcome. In one embodiment, the deadline may be fixed, e.g. non-flexible, or floating. The floating deadline includes several variants of a deadline for completion of one task, and changing the deadline according to actual performance.

Tools in the form of task organizers are commonly used to manage events, task assignments, and corresponding deadlines. It is understood that tasks organizers are commonly digital and manage tasks and corresponding characteristics. Task organizers may leverage a secondary task tool, such as a digital calendar. There is a plurality of data points related to tasks and tasks management, including task duration, task difficult, risk factors, activity details, etc.

Managing task completion and corresponding task efficiency is important on a small scale and relates to local efficiencies. However, it is understood in the art, that tasks completed on a local scale may be extrapolated to a larger scale or a different environment. Activity on a small scale may be leveraged to facilitate activity on a same or similar scale, or in one embodiment a different environment. Task data that is shared enables collaboration and exchange of information. Efficiencies in one platform may be extrapolated to inefficiencies in another platform to enable modification, correction, and improvement in the task and corresponding task management. Removal or mitigation of inefficiencies of tasks creates efficiency and yields higher productivity.

Crowdsourcing is a process through which a task, problem, or project is solved and completed through a group of unofficial and geographically dispersed participants. More specifically, crowdsourcing is a joint process development or problem-solving technique that requires help from a network of people, or crowd. With crowdsourcing, task data from various sources may be gathered and classified to facilitate workload movement. More specifically, activities corresponding to tasks that are abnormal can be identified across a population and over the course of a temporal period. Collecting this information enables proactively addressing task planning issues and provides a large sample size for amending task and workflow management. Accurate planning recommendation can be attained by comparing tasks across similar populations. Accordingly, crowdsourcing a sampling size of data collected provides a baseline for a normal distribution model analysis.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a data set to solve problems and provide relevant recommendations. For example, in the field of artificial intelligent computer systems, natural language systems (such as the IBM Watson® artificially intelligent computer system or other natural language interrogatory answering systems) process natural language based on system acquired knowledge. To process natural language, the system may be trained with data derived from a database or corpus of knowledge, but the resulting outcome can be incorrect or inaccurate for a variety of reasons.

Machine learning (ML), which is a subset of AI, utilizes algorithms to learn from data and create foresights based on this data. More specifically, ML is the application of AI through creation of neural networks that can demonstrate learning behavior by performing tasks that are not explicitly programmed. Deep learning is a type of ML in which systems can accomplish complex tasks by using multiple layers of choices based on output of a previous layer, creating increasingly smarter and more abstract conclusions.

At the core of AI and associated reasoning lies the concept of similarity. The process of understanding natural language and objects requires reasoning from a relational perspective that can be challenging. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly.

In the field of information technology (IT), electronic interfaces are commonly utilized for communication and organization, including electronic mail, electronic calendars, workflow templates, and workflow management. It is understood in the art that workflow is separated into a plurality of tasks, some which may be completed con-currently, and some which must be completed consecutively. Most, if not all, tasks have a corresponding deadline which identifies a desired point by which the task must or should be completed. In an electronic workflow management, the start and end of a task is electronically tracked, e.g. the start and end times are entered in a workflow management tool. Digital calendars may be embodied or attached to the workflow management tool. Similarly, activity details, such as technical aspects of the tasks, team members, task difficulty, risk factors, etc., are also entered in the corresponding tool. Each of the tasks items has corresponding data points.

As shown and described herein, a system, method, and computer program product are provided and directed at collecting and evaluating task and task related data points across a sampled population, e.g. sample size, to conduct a normal distribution model analysis. The embodiments leverage a neural network for reinforcement learning for decision making with respect to task, task and project management, and remedial modification or amendment of one or more tasks. The reinforcement learning incorporates crowdsourcing to identify statistically significant deviations corresponding to task movement, e.g. deviations from milestone(s). It is understood that there may be uncertainty of an event that may necessitate task deviation. As shown and described in detail below, the reinforcement learning includes an assessment of the task(s) and task characteristics, e.g. duration, difficulty, etc., identifying remediation for the tasks movement, and physically implementing the identified remediation to return to mitigate further tasks movement. Accordingly, the system and processes shown and described in detail below demonstrate use of ML to account for identification of task movement, e.g. task deviation, determine a remediation or remediating activity to mitigate or resolve the task movement, and facilitate execution of the remediation or remediating activity.

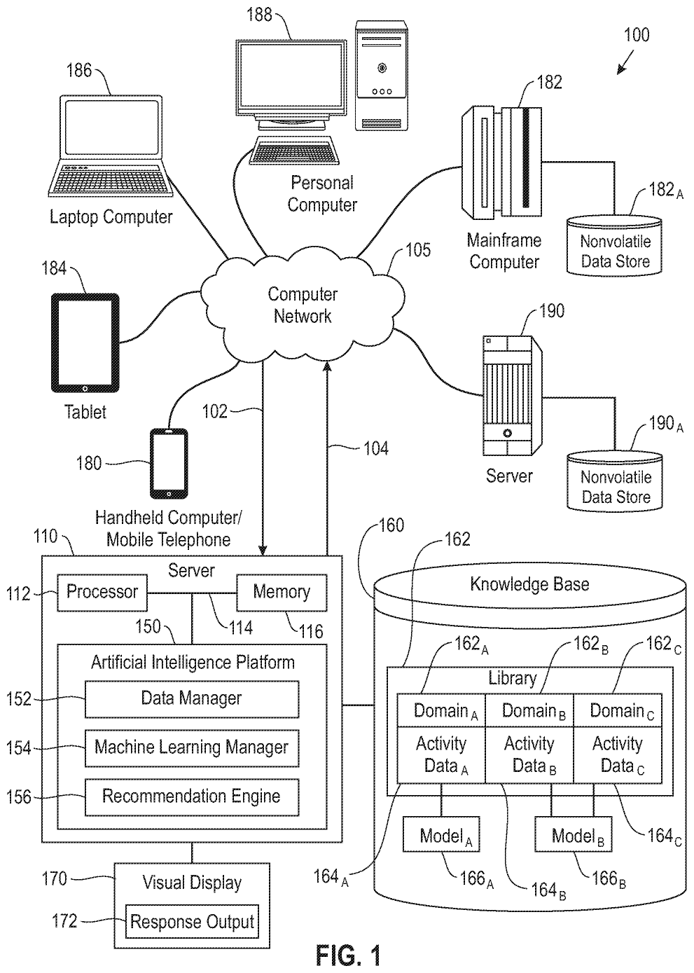

Referring to FIG. 1, a schematic diagram of an artificial intelligence platform computing system (100) is depicted. As shown, a server (110) is provided in communication with a plurality of computing devices (180), (182), (184), (186), (188), and (190) across a network connection (105). The server (110) is configured with a processing unit (112) in communication with memory (116) across a bus (114). The server (110) is shown with an artificial intelligence (AI) platform (150) for cognitive computing, including natural language processing and machine learning, over the network (105) from one or more of the computing devices (180), (182), (184), (186), (188), and (190). More specifically, the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network connection (105) enable communication detection, recognition, and resolution. Other embodiments of the server (110) may be used with components, systems, sub-systems, and/or devices other than those that are depicted herein.

The AI platform (150) is shown herein configured with tools to enable supervised learning. The tools function to cognitively assess task characteristic data, identify one or more deviations corresponding to tasks process and completion, and design an optimization methodology to mitigation or otherwise eliminate the one or more identified deviations using ML techniques. The tools include, but are not limited to, a data manager (152), a machine learning (ML) manager (154), and a recommendation engine (156). The AI platform (150) may receive input from the network (105) and leverage a data source (160), also referred to herein as a corpus or knowledge base, to selectively access task and corresponding task activity data. As shown the data source (160) is configured with a library (162) with a plurality of classification models that are created and managed by the ML manager (154). Details of how the models are created are shown and described in detail below. It is understood that different domains, such as different business organizations or departments within the business organization may each be classified as a domain. In the example shown herein, the domains include, but are not limited to, domain_{A} (162_{A}), domain_{B} (162_{B}), and domain_{C} (162_{C}). Although only three domains are shown and represented herein, the quantity should not be considered limiting. In one embodiment, there may be a different quantity of domains. Similarly, domains may be added to the library (162). Corresponding task and task activity data, hereinafter referred to as activity data, is stored or categorized with respect to each of the domains by the data manager (152). As shown, domain_{A} (162_{A}) includes activity data_{A} (164_{A}), domain_{B} (162_{B}) includes activity data_{B} (164_{B}), and domain_{C} (162_{C}) includes activity data_{C} (164).

It is understood that supervised learning leverages data from a data source. As shown herein, the data source is referred to as the knowledge base (160) and is configured with domains and logically grouped activity data in the form of models. The data manager (152) functions to collect or extract data from the various computing devices (180), (182), (184), (186), (188), and (190) in communication with the network (105). Once collected, the ML manager (154) organizes or arranges the collected data from one or more of the computing devices into one or more of the corresponding models. Models may be created based on an intra-domain activity or inter-domain activity. Two models are shown herein, although the quantity and their relationships to the domains should not be considered limiting. Model_{A} (166_{A}) is shown operatively coupled to activity data (164_{A}), and is an intra-domain activity model. Model_{B} (166_{B}) is shown operatively coupled to activity data_{B} (164_{B}) and activity data_{C} (164_{C}) and is an inter-domain activity model, also referred to herein as a multi-class classification model. The models reflect and organize activity data corresponding to the respective domain, including electronic mail communications and electronic calendar data. In one embodiment, each domain may be linked or associated with a plurality of email addresses, in which one or more topics form a communication thread. As tasks and tasks completion or non-completion data is detected, corresponding activity data is updated by the data manager (152), and each model configured and operatively coupled to the activity data is dynamically updated by the ML manager (154).

It is understood that data may be collected at periodic intervals, upon completion of a task, or omission of a milestone related to the task, with the data manager (152) collecting the data or changes in the data and the ML manager (154) reflecting the collected or changed data in an appropriately classified or operatively coupled model. In one embodiment, the data manager (152) may function in a dynamic manner, including, but not limited to, detecting changes to the collected data, and collecting the changed data. Similarly, the ML manager (154) utilizes one or more ML algorithm(s) to update a corresponding model to reflect and incorporate the data changes. In one embodiment, the data manager (152) may function in a sleep or hibernate mode when inactive, e.g. not collecting data, and may change to an active mode when changes to relevant or pertinent data are discovered. A project may be comprised of a single task or multiple tasks. In the case of multiple tasks, one task may be classified as dependent or independent. Similarly, tasks may have corresponding milestones directed at anticipated or required completion or partial completion and an associated or anticipated completion deadline. The data manager (152) may function responsive to the milestones, including collecting data or changing functional states responsive to attainment or non-attainment of the corresponding milestones. Accordingly, the data manager (152) functions as a tool to collect and organize data from one or more computing devices, with the ML manager (154) reflecting the organized data into one or more models.

The ML manager (154), which is shown herein operatively coupled to the data manager (152), functions as a tool to dynamically assess probability with respect to tasks, task milestone attainment, task completion, etc., based on the collected data reflected in the models. The ML manager (154) employs a probability algorithm to evaluate task milestone related data, including learn values of tasks states or task state histories, and to maximize utility of outcomes. States can involve various different states, including, but not limited to, individual task milestone states, multi-task milestone states, etc. The probability algorithm creates a distribution model associated with the task subject to evaluation and associated task milestone data, and produces output directed at identification of task or task milestone outliers or deviations. The ML manager (154) identifies factors corresponding to task metadata, including assignment of the task, entity responsible for completion of the task, digital calendar data for the assigned entity, digital calendar data for task team members, task duration, task difficulty, risk factors, etc., and uses these factors to generate a probability output.

In addition to identification of task related factors, the data manager (152) identifies the same or similar tasks for the same entity or a different entity, hereinafter referred to as a secondary task, and collects task characteristic data for the identified secondary tasks. The ML manager (154) incorporates the secondary tasks into the probability algorithm to evaluate task milestone related data, including learn values of tasks states or task state histories, and to maximize utility of outcomes. The probability algorithm creates a distribution model associated with the task and the secondary task(s). The distribution model evaluates the task under consideration with respect to the secondary task(s), and produces output directed at identification of task or task milestone outliers or deviations in view of the secondary task(s). The ML manager (154) identifies factors corresponding to task metadata, including assignment of the task, entity responsible for completion of the task, digital calendar data for the assigned entity, digital calendar data for task team members, task duration, task difficulty, risk factors, etc., and uses these factors to generate a probability output.

The ML manager (154) may implement a time range, e.g. a temporal segment, with respect to the task being evaluated, and incorporate the time range into the distribution model. The ML manager (154) leverages the model(s) and assesses the distribution to identify any outliers of the task in view of the temporal segment. In one embodiment, the distribution model is a Gaussian distribution and the outlier is a task identified by data points that are within one or more deviations from the mean, e.g. standard deviations. In one embodiment, the ML manager (154) updates or re-assesses the probability in response to collection of new data. Similarly, in one embodiment, the data manger (152) is monitoring and collecting data from an email thread or collects data from the calendar, and the ML manager (154) re-assesses the probability as new task related data is detected or otherwise attained. Accordingly, the ML manager (154) interfaces with the data manager (152) to maintain the probability assessment current with the state of the collected and relevant task and task related data.

Using the collected data by the data manager (152) and the probability output produced by the ML manager (154), the operatively coupled recommendation engine (156) conducts an analysis of reinforcement learning for decision making with the goal of minimizing task deviation. It is understood in the art that a task may individually or collectively deviate from a schedule, which in one embodiment is documented in the form of milestones. The reinforcement learning recommends an action in the form of amending one or more milestones, re-arrangement of one or more tasks, or re-assignment of one or more tasks. The recommendation provided by the recommendation engine is based on current milestone assessment, similar or related tasks and their milestone data, and historical trends of the current or related tasks. In one embodiment, the reinforcement learning may produce a selection of available mitigation options.

The recommendation engine (156) formulates an objective and physical output or physical implementation of the output based on considering multiple factors and produces output in the form of a recommendation to amend the task that is the subject of the evaluation. The recommendation output includes the recommendation engine (156) to selectively conduct an action correlating with the recommendation. Accordingly, as shown herein the recommendation engine (156) formulates an objective function based on considering multiple factors, generates an output from the objective function, and applies the generated output to selectively conduct task modification or task assignment modification.

The analysis conducted by the recommendation engine (156) creates a measurement of impact on modification of the task, and is conducted dynamically. As shown, the ML manager (154) is operatively coupled to the data manager (152). The ML manager (154) conducts supervised learning responsive to an electronic fingerprint, which in one embodiment may include, but is not limited to, electronic mail and calendar data or changes corresponding to the mail and calendar data. The ML manager (154) also gathers data of the same task previously undertaken by the same entity or a similar entity. For example, in one embodiment, the ML manager (154) employs crowdsourcing to gather task and task related data. The ML manager (154) dynamically updates the probability assessment, and reflects the update(s) in one or more corresponding models. The recommendation engine (156) orchestrates a sequence of actions responsive to the electronic fingerprint data, such as detected electronic mail and calendar activities, as well as crowdsourced task data from secondary data sources. In one embodiment, the secondary data includes task data from an external source, and corresponding task trends, such as task milestones and attainment or non-attainment of the milestones. The secondary data sources are accessible to the recommendation engine (156) across the network (105). It is understood that the secondary data is dynamic and may affect the produced outcome (172), also referred to herein as response output. The recommendation engine (156) generates a policy based on data obtained from one or more secondary data sources and output from the ML manager (154), with the generated policy being in the form of a recommendation of actions and to direct task planning optimization.

The data mining and supervised learning conducted by the data manager (152) and ML manager (154), respectively, may be conducted offline or as one or more background processes. The ML manager (154), which is shown herein operatively coupled to the data manager (154), functions as a tool to dynamically generate a probability assessment for the data gathered by the data manager (152). The ML manager (154) employs a supervised learning algorithm to assess probability of outcomes, such as probability of meeting a corresponding task milestone, as well as probability of missing one or more task milestones. The recommendation engine (156) leverages the probability to assess and to maximize utility of outcomes.

The ML manager (154) enables and supports use of machine learning (ML) with respect to optimization of the probability assessment. In one embodiment, a corresponding machine learning model (MLM) encapsulates a corresponding ML algorithm. The MLM functions to dynamically learn values of task milestones and task characteristic data as the characteristic data are subject to change. The ML manager (154) discovers and analyzes patterns, and corresponding deviations. As task data is detected or gathered, the ML manager (154) may dynamically amend a prior probability assessment. The ML manager (154) supports elasticity and the complex characteristics of diverse task characteristics and task metadata across a plurality of devices in the network. Accordingly, patterns of task activity data are learned over time and used for dynamically orchestrating or amending the probability assessment.

Response output (172) in the form of one or more of the derived actions, such as task modification or task assignment modification. A sequence of actions or an amended sequence of actions as related to the task under evaluation is communicated or otherwise transmitted to the processing unit (112) for execution. In one embodiment, the response output (172) is communicated to a corresponding network device, shown herein as a visual display (170), operatively coupled to the server (110) or in one embodiment, operatively coupled to one or more of the computing devices (180)-(190) across the network connection (104).

As shown, the network (105) may include local network connections and remote connections in various embodiments, such that the AI platform (150) may operate in environments of any size, including local and global, e.g. the Internet. Additionally, the AI platform (150) serves as a front-end system that can make available a variety of knowledge extracted from or represented in network accessible sources and/or structured data sources. In this manner, some processes populate the AI platform (150), with the artificial intelligence platform (150) also including input interfaces to receive requests and respond accordingly.

The knowledge base (160) is configured with logically grouped domains (162_{A})-(162_{C}) and corresponding models (166_{A})-(166_{B}), respectively, for use by the AI platform (150). In one embodiment, the knowledge base (160) may be configured with other or additional sources of input, and as such, the sources of input shown and described herein should not be considered limiting. Similarly, in one embodiment, the knowledge base (160) includes structured, semi-structured, and/or unstructured content related to activities and tasks. The various computing devices (180)-(190) in communication with the network (105) may include access points for the logically grouped domains and models. Some of the computing devices may include devices for a database storing the corpus of data as the body of information used by the AI platform (150) to generate response output (172) and to communicate the response output to a corresponding network device, such as a visual display (170), operatively coupled to the server (110) or one or more of the computing devices (180)-(190) across network connection (104).

The network (105) may include local network connections and remote connections in various embodiments, such that the artificial intelligence platform (150) may operate in environments of any size, including local and global, e.g. the Internet. Additionally, the artificial intelligence platform (150) serves as a front-end system that can make available a variety of knowledge extracted from or represented in network accessible sources and/or structured data sources. In this manner, some processes populate the AI platform (150), with the AI platform (150) also including one or more input interfaces or portals to receive requests and respond accordingly.

The AI platform (150), via a network connection or an internet connection to the network (105), is configured to detect and manage network activity and task data as related to travel and travel scheduling. The AI platform (150) may effectively orchestrate or optimize an orchestrated sequence of actions directed at related activity data by leveraging the knowledge base (160), which in one embodiment may be operatively coupled to the server (110) across the network (105).

The AI platform (150) and the associated tools (152)-(156) leverage the knowledge base (160) to support orchestration of the sequence of actions directed to task management, and supervised learning to optimize the sequence of actions directed to task management. The recommendation engine (156) leverages the probability assessment conducted by the ML manager (154), and orchestrates an action or a sequence of actions directed at task management and task related activities. Accordingly, the tools (152)-(156) mitigate deviation associated with task management and completion or rescheduling by assessing such probability associated with correlated actions, orchestrating a recommendation, and dynamically optimizing the recommendation orchestration.

Task characteristic and related data, such as, but not limited to electronic mail data and electronic calendar entries are subject to change, and the ML manager (154) and the recommendation engine (156) are configured to dynamically respond to detected changes. It is understood that as the electronic mail data and/or calendar entry data changes, a corresponding probability assessment may be subject to change. The ML manager (154) is configured to dynamically adjust to such changes, including, but not limited to learning values of states or state histories, and mapping states to probability assessment actions.

Activity data, e.g. electronic mail and calendar entries, received across the network (105) may be processed by a server (110), for example IBM Watson® server, and the corresponding AI platform (150). As shown herein, the AI platform (150) together with the embedded managers (152)-(154) and engine (156) perform an analysis of the activity data and tasks, dynamically conduct or update a probability assessment, as well as generate one or more recommendations for selection. Accordingly, the function of the tools and corresponding analysis is to embed dynamic supervised learning to minimize deviations in task scheduling and completion.

In some illustrative embodiments, the server (110) may be the IBM Watson® system available from International Business Machines Corporation of Armonk, N.Y., which is augmented with the mechanisms of the illustrative embodiments described hereafter. The manager (152)-(154) and engine (156), hereinafter referred to collectively as AI tools, are shown as being embodied in or integrated within the AI platform (150) of the server (110). The AI tools may be implemented in a separate computing system (e.g., 190), or in one embodiment they can be implemented in one or more systems connected across network (105) to the server (110). Wherever embodied, the AI tools function to dynamically optimize activities to minimize, or otherwise mitigate, risk.

Types of devices and corresponding systems that can utilize the artificial intelligence platform (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various devices and systems can be networked together using computer network (105). Types of computer network (105) that can be used to interconnect the various devices and systems include Local Area Networks (LANs), Wireless Local Area Networks (WLANs), the Internet, the Public Switched Telephone Network (PSTN), other wireless networks, and any other network topology that can be used to interconnect the devices and systems. Many of the devices and systems include nonvolatile data stores, such as hard drives and/or nonvolatile memory. Some of the devices and systems may use separate nonvolatile data stores (e.g., server (190) utilizes nonvolatile data store (190_{A}), and mainframe computer (182) utilizes nonvolatile data store (182_{A}). The nonvolatile data store (182_{A}) can be a component that is external to the various devices and systems or can be internal to one of the devices and systems.

The device(s) and system(s) employed to support the artificial intelligence platform (150) may take many forms, some of which are shown in FIG. 1. For example, an information handling system may take the form of a desktop, server, portable, laptop, notebook, or other form factor computer or data processing system. In addition, the device(s) and system(s) may take other form factors such as a personal digital assistant (PDA), a gaming device, ATM machine, a portable telephone device, a communication device or other devices that include a processor and memory.

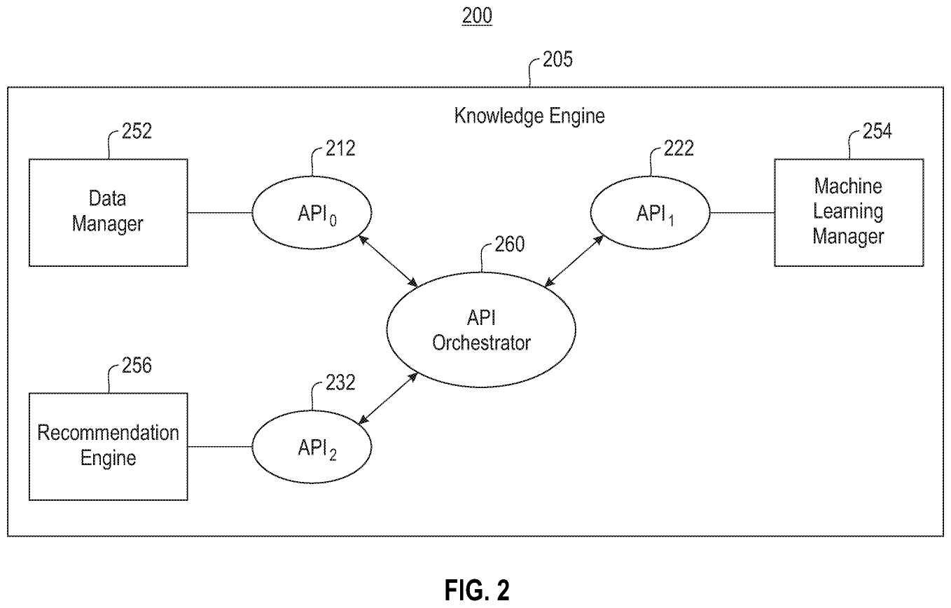

An Application Program Interface (API) is understood in the art as a software intermediary between two or more applications. With respect to the AI platform (150) shown and described in FIG. 1, one or more APIs may be utilized to support one or more of the tools (152)-(156) and their associated functionality. Referring to FIG. 2, a block diagram (200) is provided illustrating the tools (252)-(256) and their associated APIs. As shown, a plurality of tools is embedded within the AI platform (205), with the tools including the data manager (152) shown herein as (252) associated with API₀ (212), the ML manager (154) shown herein as (254) associated with API₁ (222), and the recommendation engine (156) shown herein as (256) associated with API₂ (232). Each of the APIs may be implemented in one or more languages and interface specifications. API₀ (212) provides functional support to collect and collate task and task characteristic data on an intra-domain or inter-domain basis; API₁ (222) provides functional support for ML and supervised learning for probability assessment corresponding to the collected and collated task and task characteristic data; and API₂ (232) provides functional support to dynamically optimize and orchestrate task management and task amendment recommendation to minimize deviations. As shown, each of the APIs (212), (222), and (232) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

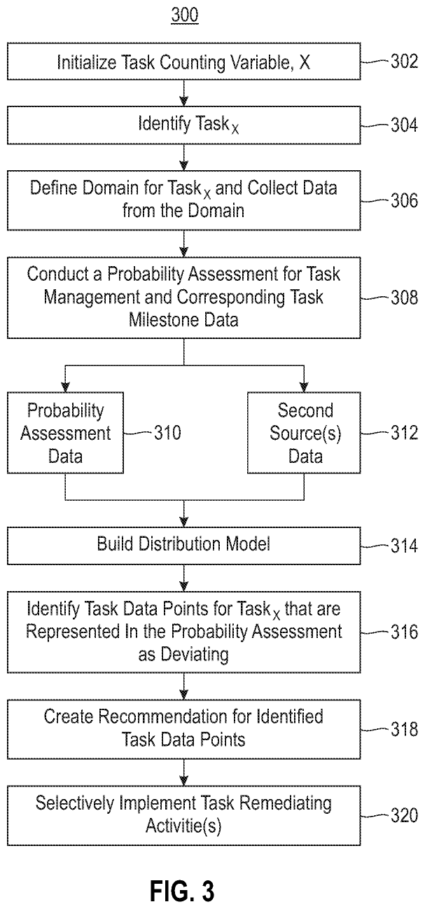

Referring to FIG. 3, a flow chart (300) is provided illustrating functionality of applying machine learning and a corresponding neural network to task management. In the area of information technology, projects and corresponding tasks have a digital profile, and as such a corresponding digital footprint. Task characteristic data is digitally identified and documented. Data corresponding to one or more tasks has corresponding metadata that documents when the time and data that related task activity has taken place. In one embodiment, the tasks metadata defines the start and stop times of task related activity, and as such the duration for the corresponding activity may be attained. It is understood in the art that tasks and task completion may have a corresponding completion date, e.g. deadline. Completion of the tasks is obtained as part of the tasks characteristic data. Accordingly, tasks can be managed from start to finish with the metadata identifying the entity executing the task, when the task was started, completed, and the duration. A task counting variable, X, is initialized (302), and a task, e.g. task_{X}, is identified (304). A domain associated with task_{X} is defined and data is collected from the defined domain (306). In one embodiment, the domain is comprised of members and includes a plurality of electronic mail addresses and corresponding electronic calendars for the domain members. Although the process described herein is applied to a single domain, it is understood that multiple domains may be configured or defined for supervised learning and decision making. As shown and described in FIG. 1, a ML algorithm is utilized to conduct the supervised learning, and more specifically, to conduct a probability assessment for corresponding to the task.

As shown and described in FIG. 1, a ML algorithm is utilized to conduct the supervised learning, and more specifically, to conduct a probability assessment for task management and corresponding task milestone data (308). The ML algorithm leverages or generates a classification model, hereinafter referred to as a model, for each domain. The model organizes the collected task and task related data for the corresponding domain with entries in the model reflecting attainment of task milestones. In one embodiment, the model is dynamically revised at such time as data in the corresponding domain is amended, e.g. new email is received, a calendar entry is changed, membership in the domain is amended, task are completed, tasks are omitted, etc. Accordingly, the ML algorithm extracts data from the domain threads and conducts a corresponding probability assessment.

There are two sources of input to the ML manager, including output from the probability assessment in the form of the classification model (310), and secondary data received or obtained from a plurality of secondary data sources (312). In one embodiment, the secondary data is collected from a plurality of domains, which in one embodiment may operate independently. With respect to processing and execution of tasks, the secondary data may include task completion data for the same task at a different period of time, such as with respect to a different project, task completion data for a similar or related tasks, task completion data from a crowdsourcing domain for the same task or a similar task, etc. The ML manager pulls data from both the output from the probability assessment and the secondary data (312) and builds a distribution model (314). The crowdsourcing is an expansion to gather data from an open environment, whether within or outside the same entity. Data acquired from the crowdsourcing is joined with the task data. Accordingly, task characteristic data can be obtained from a plurality of sources.

The probability assessment is leveraged to identify task data points for task_{X} that are represented in the probability assessment as deviating from the mean (316). In one embodiment, the identification utilizes a threshold. For example, in one embodiment, data that is within the first deviation of the mean may be acceptable, with the concern being data that is separated from the mean by two or more standard deviations. A recommendation is created for each task_{X} data point determined to be separated from the mean as defined by the threshold (318). The recommendation generates one or more forms of remediation to mitigate the deviation, such as, but not limited to, task re-assignment or task re-arrangement, etc. The task remediating activities are selectively implemented (320).

The task remediation may have multiple components, and the selective implementation enables selection of less than all of the task remediation components. In one embodiment, program code or a script may be employed for the selective implementation. Similarly, in one embodiment, the task remediation activities and components may be presented on a visual display with indicia conveying an associated recommendation. Accordingly, output from the recommendation is provided to facilitate implementation of one or more task remediating activities.

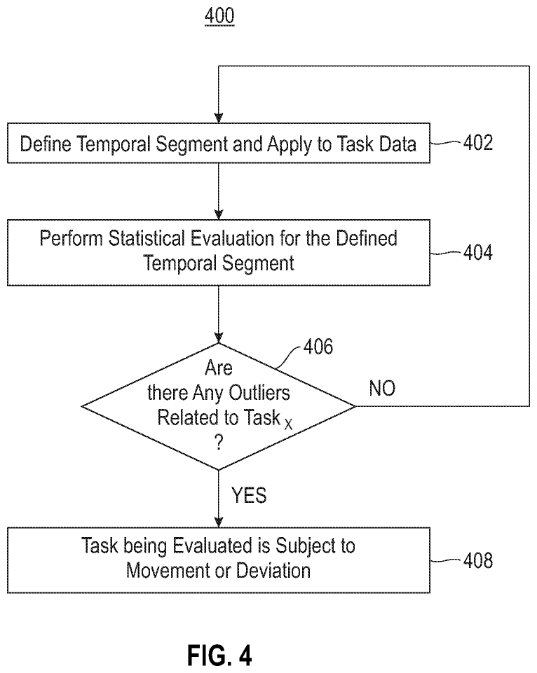

One of the objectives with gathering task characteristic data is to detect deviations associated with task performance. For example, in one embodiment, task characteristic data may indicate that execution of the task and corresponding time to completion may vary based on the time of day that the task takes place. In another embodiment, task characteristic data may indicate that execution of the task and corresponding time to completion may vary based on the entity executing the task, location of the execution, placement of the task within a project, task team members, etc. Referring to FIG. 4, a flow chart (400) is provided to illustrate a process for leveraging a time constraint characteristic into the probability assessment. Using the primary, and in one embodiment also the secondary, task data and task milestone data, as shown in FIG. 3, a temporal segment is defined and applied to the gathered task data (402). The collected data is subject to a statistical evaluation for the defined temporal segment (404). The statistical evaluation provides an analysis of one or more of the gathered data points and one or more corresponding measurements of the collected task and task characteristic data. In one embodiment, the statistical evaluation at step (404) creates or otherwise provides a graphical representation of the task characteristic data for the defined temporal segment. The graphical representation provides a visual depiction of the task characteristic data.

The goal of identifying and gathering tasks data is to identify patterns corresponding to the identified task and prior execution of the task, and more specifically to identify task movement, e.g. statistical deviations correspond to the task, within the defined temporal segment. The movement may be identified numerically, or in the case of a graphical presentation the movement may be visually identified. The statistical evaluation at (404) is directed to identifying any movement of task_{X} presented in the statistical evaluation of related task data. In one embodiment, the evaluation at step (404) revolves around the task that is subject to evaluation in view of the gathered data. Task_{X} is the subject of the evaluation, so that it can be determined if task_{X} by a specific entity is deviating from a corresponding spectrum. In one embodiment, the temporal segment defines a time interval with respect to the calendar, e.g. a fixed period in time. Similarly, in one embodiment, the statistical evaluation at step (404) employs a Gaussian distribution to derive a continuous probability distribution model. Through the Gaussian distribution, one or more outliers within the model may be apparent. Using the statistical task evaluation, it is determined if there are any outliers, and if so, if any of those outliers are related to task_{X} (406). In one embodiment, the determination at step (406) may be directed to one or more standard of deviations with respect to the mean. If at step (406) it is determined that there are no outliers for task_{X}, then the process returns to step (402) to continue gathering data for the task. However, a positive response to the determination at step (406) is an indication that the task, e.g. task_{X}, has been identified as subject to movement or some form of deviation with respect to the same or related tasks within the defined temporal segment (408). Accordingly, the task under consideration is subject to evaluation with respect to task data to ascertain task movement.

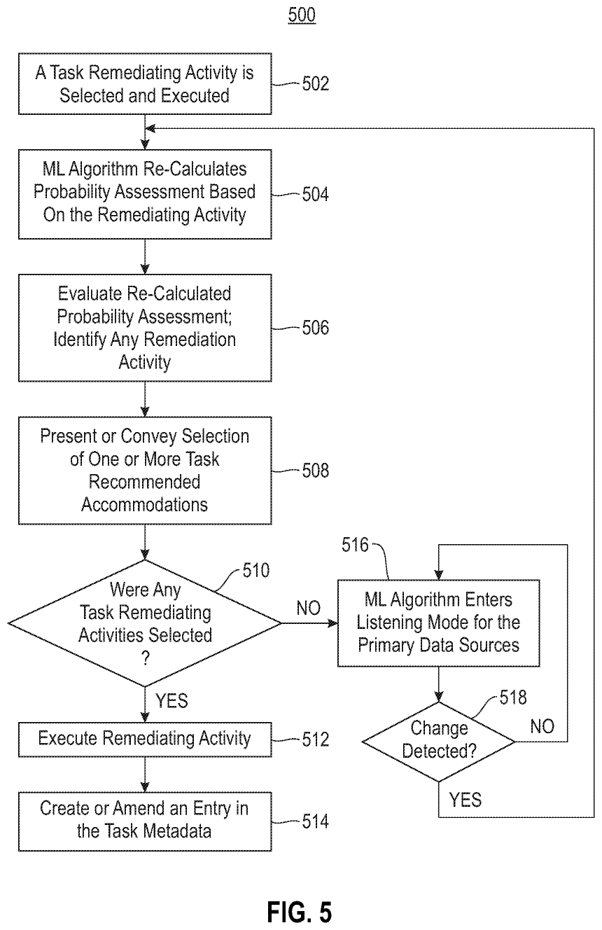

Task movement may be significant or insignificant. Similarly, implementation of one or more task remediation activities may affect one or more different tasks. Referring to FIG. 5, a flow chart (500) is provided to illustrate selection and implementation of a task remediation activity. As shown and described in FIG. 1, a machine learning (ML) manager and a corresponding ML model is applied to the tasks evaluation and task movement identification. The ML model employs a neural model and encapsulates a corresponding ML algorithm to recognize the deviation and one or more corresponding remediation activities. The ML model discovers and analyzes patterns associated with the task, e.g. task_{X}. In one embodiment, the ML model creates the probability distribution model and identifies any corresponding deviations. It is understood that as data continues to be gathered and applied, new patterns may evolve, and the ML model may dynamically re-apply the probability distributions to identify any evolved deviations. Similarly, as task remediation activities are selected or otherwise executed, there may be an effect on one or more separate tasks.

Task remediation activities are directed at resolving one or more deviations identified in the model. Examples of the remediation activity include, but are not limited to: re-assignment of the tasks to a different entity, amending a schedule for completion of the tasks, re-arranging the tasks in a multi-task assignment, etc. The remediation activity is a physical action that will create a new physical output. It is understood that the remediating activity may be communicated in the form of a suggestion in view of a detected outlier in the probability distribution. As shown and described in FIG. 1, the ML model may identify the remediating activities as a recommendation, which in one embodiment may be selectively implemented. In one embodiment, the remediating activities may have multiple components, and the selective implementation enables selection of less than all of the remediating actions.

As shown, a task remediating activity is selected and executed (502). The ML algorithm re-calculates the probability assessment based on the executed remediating activity (504). In one embodiment, the re-calculated probability assessment is a new assessment based on a change in the task and task processing. In one embodiment, the task remediating activity may be selected, and the model may be executed to simulate a re-calculated probability assessment to demonstrate the projected effects based on the selected remediation activity. The re-calculated probability assessment is evaluated to identify any further remediation activities (506). Whether simulated or real, selection of any remediating activity may have an effect on another task or task component. For example, a project may be comprised of a plurality of tasks, identified and conducted in the order as follows: task₀→task₁→task₂→task₃→task₄. The remediating activity may create or suggest a new order or amended order of the tasks, such as: task₀→task₁→task₃→task₂→task₄. Although this example merely changes the order of task processing by having task₃ take place prior to task₂, with the understanding that the act of executing task₃ prior to task₂, may affect task₂, as the output from task₃ may play a role in the execution of task₂.

Using the output from the recommendation engine, one or more task remediating activities are communicated. A selection of one or more of the recommended accommodations are presented or otherwise conveyed (508), and it is determined if any of the task remediating activities have been selected (510). A positive response to the determination at step (510) is followed by execution of the remediating activity (512). In addition, an entry is created or amended in the task metadata, and in one embodiment corresponding project metadata (514). However, a negative response to the determination at step (510) is followed by the ML algorithm entering a listen mode with respect to the primary data sources, and in one embodiment the secondary data sources (516). In one embodiment, the recommendation engine launches a script to listen for changes on the secondary data sources as related to the domain. At such time as a change is detected in either the primary or secondary data source (518), or both, the process returns to step (504) to dynamically reflect the change and re-assessed probability into the model. If no change is detected, the ML algorithm continues to listen (516). Accordingly, the ML algorithm listens for changes to the primary and secondary data sources.

In one embodiment, and until such time as the task remediating activity executes, the listening mode of the ML algorithm, and in one embodiment the listening script of the recommendation engine continue as background processes. It is understood that the listening at step (516) may include monitoring corresponding email thread and calendar(s) to detect task related data and metadata. Accordingly, listening to the primary and secondary data sources facilitates thread monitoring and probability re-assessment.

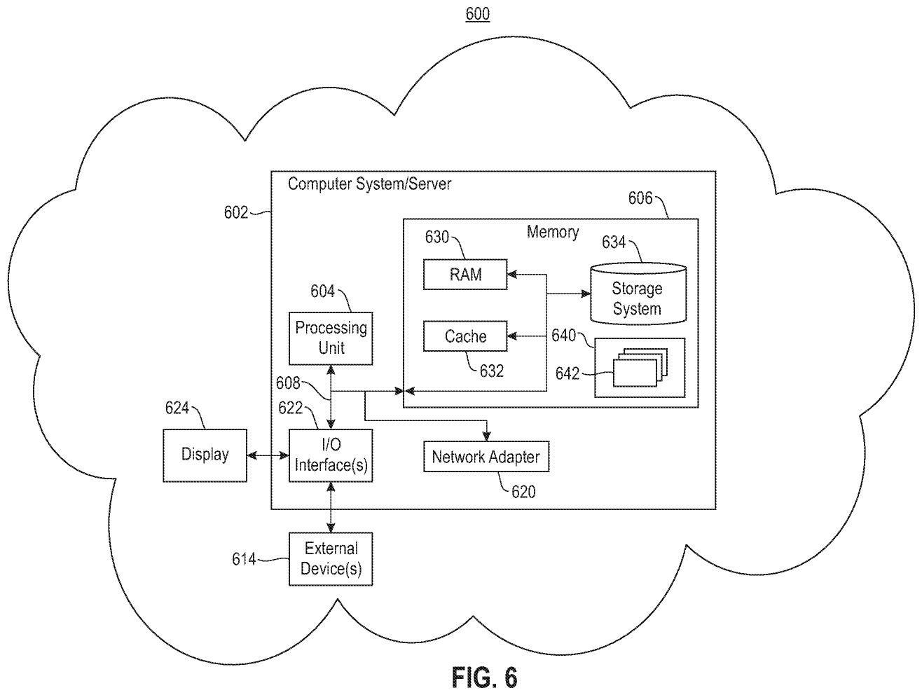

Embodiments shown and described herein may be in the form of a computer system for use with an intelligent computer platform for providing orchestration of activities across one or more domains to minimize risk. Aspects of the tools (152)-(156) and their associated functionality may be embodied in a computer system/server in a single location, or in one embodiment, may be configured in a cloud based system sharing computing resources. With references to FIG. 6, a block diagram (600) is provided illustrating an example of a computer system/server (602), hereinafter referred to as a host (602) in communication with a cloud based support system, to implement the system, tools, and processes described above with respect to FIGS. 1-5. Host (602) is operational with numerous other general purpose or special purpose computing system environments or configurations. Examples of well-known computing systems, environments, and/or configurations that may be suitable for use with host (602) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (602) may be described in the general context of computer system-executable instructions, such as program modules, being executed by a computer system. Generally, program modules may include routines, programs, objects, components, logic, data structures, and so on that perform particular tasks or implement particular abstract data types. Host (602) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, host (602) is shown in the form of a general-purpose computing device. The components of host (602) may include, but are not limited to, one or more processors or processing units (604), e.g. hardware processors, a system memory (606), and a bus (608) that couples various system components including system memory (606) to processor (604). Bus (608) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (602) typically includes a variety of computer system readable media. Such media may be any available media that is accessible by host (602) and it includes both volatile and non-volatile media, removable and non-removable media.

Memory (606) can include computer system readable media in the form of volatile memory, such as random access memory (RAM) (630) and/or cache memory (632). By way of example only, storage system (634) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (608) by one or more data media interfaces.

Program/utility (640), having a set (at least one) of program modules (642), may be stored in memory (606) by way of example, and not limitation, as well as an operating system, one or more application programs, other program modules, and program data. Each of the operating systems, one or more application programs, other program modules, and program data or some combination thereof, may include an implementation of a networking environment. Program modules (642) generally carry out the functions and/or methodologies of embodiments to dynamically orchestrate of activities across one or more domains to minimize risk. For example, the set of program modules (642) may include the tools (152)-(156) as described in FIG. 1.

Host (602) may also communicate with one or more external devices (614), such as a keyboard, a pointing device, etc.; a display (624); one or more devices that enable a user to interact with host (602); and/or any devices (e.g., network card, modem, etc.) that enable host (602) to communicate with one or more other computing devices. Such communication can occur via Input/Output (I/O) interface(s) (622). Still yet, host (602) can communicate with one or more networks such as a local area network (LAN), a general wide area network (WAN), and/or a public network (e.g., the Internet) via network adapter (620). As depicted, network adapter (620) communicates with the other components of host (602) via bus (608). In one embodiment, a plurality of nodes of a distributed file system (not shown) is in communication with the host (602) via the I/O interface (622) or via the network adapter (620). It should be understood that although not shown, other hardware and/or software components could be used in conjunction with host (602). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (606), including RAM (630), cache (632), and storage system (634), such as a removable storage drive and a hard disk installed in a hard disk drive.

Computer programs (also called computer control logic) are stored in memory (606). Computer programs may also be received via a communication interface, such as network adapter (620). Such computer programs, when run, enable the computer system to perform the features of the present embodiments as discussed herein. In particular, the computer programs, when run, enable the processing unit (604) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In one embodiment, host (602) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

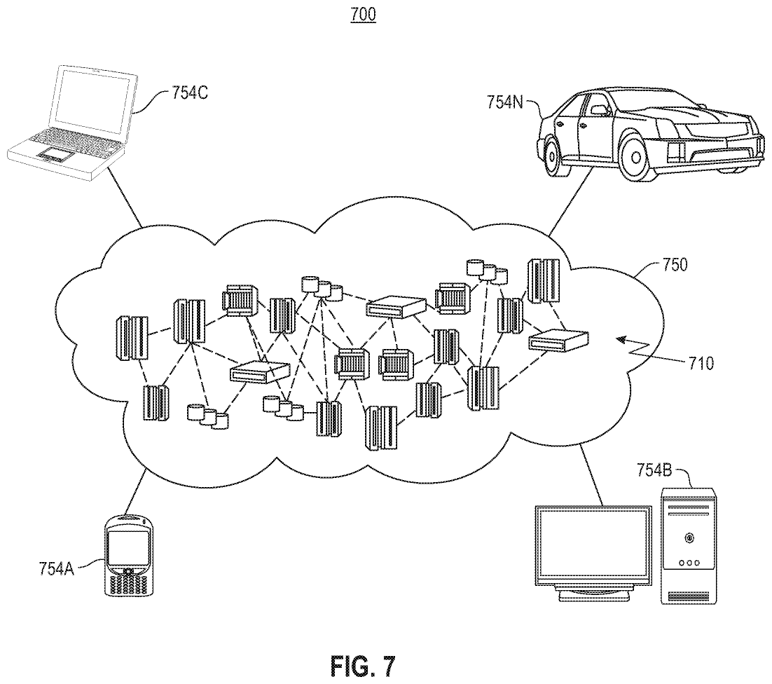

Referring now to FIG. 7, an illustrative cloud computing network (700). As shown, cloud computing network (600) includes a cloud computing environment (750) having one or more cloud computing nodes (710) with which local computing devices used by cloud consumers may communicate. Examples of these local computing devices include, but are not limited to, personal digital assistant (PDA) or cellular telephone (754A), desktop computer (754B), laptop computer (754C), and/or automobile computer system (754N). Individual nodes within nodes (710) may further communicate with one another. They may be grouped (not shown) physically or virtually, in one or more networks, such as Private, Community, Public, or Hybrid clouds as described hereinabove, or a combination thereof. This allows cloud computing environment (700) to offer infrastructure, platforms and/or software as services for which a cloud consumer does not need to maintain resources on a local computing device. It is understood that the types of computing devices (754A-N) shown in FIG. 7 are intended to be illustrative only and that the cloud computing environment (750) can communicate with any type of computerized device over any type of network and/or network addressable connection (e.g., using a web browser).

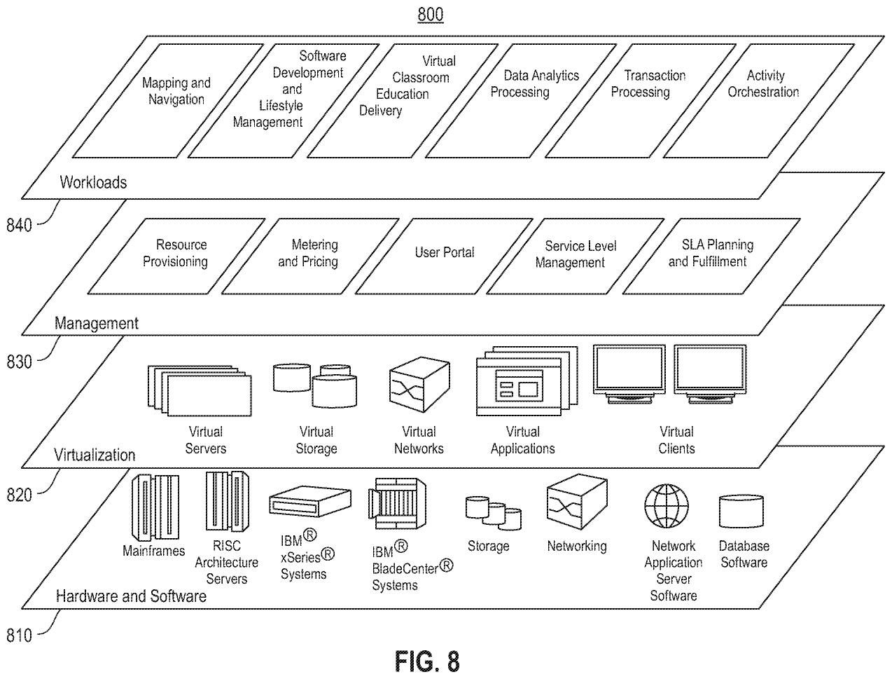

Referring now to FIG. 8, a set of functional abstraction layers (800) provided by the cloud computing network of FIG. 7 is shown. It should be understood in advance that the components, layers, and functions shown in FIG. 8 are intended to be illustrative only, and the embodiments are not limited thereto. As depicted, the following layers and corresponding functions are provided: hardware and software layer (810), virtualization layer (820), management layer (830), and workload layer (840).

The hardware and software layer (810) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (820) provides an abstraction layer from which the following examples of virtual entities may be provided: virtual servers; virtual storage; virtual networks, including virtual private networks; virtual applications and operating systems; and virtual clients.

In one example, management layer (830) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (840) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and task activity orchestration.

It will be appreciated that there is disclosed herein a system, method, apparatus, and computer program product for evaluating natural language input, detecting an interrogatory in a corresponding communication, and resolving the detected interrogatory with an answer and/or supporting content.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product is operative to improve the functionality and operation of an artificial intelligence platform to resolve orchestration of travel activities and meeting scheduling.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. Accordingly, the scope of protection of the embodiments is limited only by the following claims and their equivalents.

What is claimed is:

1. A computer system comprising:
a processing unit operating coupled to memory;
an artificial intelligence (AI) platform in communication with the processing unit, the AI platform to implement task planning, the AI platform comprising:
a task manager to collect and track tasks and task characteristics over one or more defined temporal segments;
an analyzer to temporally analyze one or more data points and corresponding measurements of the collected and tracked tasks and task characteristics, including analyze task movement;
responsive to identification of a statistical deviation in the analyzed one or more data points, the analyzer to identify statistically significant data associated with one or more of the tracked tasks;
a path manager to modify a path of one or more of the tracked tasks, the modification to create an optimal delivery path in view of the identified statistical deviation; and
the processing unit to selectively execute one or more encoded actions in compliance with the modified path.

2. The system of claim 1, further comprising the task manager to classify at least one task and one task characteristic corresponding to the identified statistical deviation.

3. The system of claim 2, wherein the AI platform further comprises a machine learning (ML) manager to train a ML model to analyze the classified at least one task and one task characteristic.

4. The system of claim 3, further comprising:
the task manager to crowdsource the collected task and task characteristic data; and
the ML model to:
aggregate the collected task and task characteristic data across a select population, and
analyze the classified at least one task and one task characteristic across the aggregated data.

5. The system of claim 4, further comprising the ML manager to employ a Gaussian distribution for the aggregated data and derive a continuous probability distribution model, and the ML model to identify an outlier within the distribution model.

6. The system of claim 5, wherein the ML model path modification of one or more of the tracked tasks includes the ML model to create an association between the identified outlier and a corresponding task, and the modification including an action selected from the group consisting of: re-arranging one or more task components, re-assigning the task, and combinations thereof.

7. A computer program product for task planning, the computer program product comprising a computer readable storage medium having program code embodied therewith, the program code executable by a processor to:
collect and track tasks and task characteristics over one or more defined temporal segments;
temporally analyze one or more data points and corresponding measurements of the collected and tracked tasks and task characteristics, including analyze task movement;
responsive to identification of a statistical deviation in the analyzed one or more data points, identify statistically significant data associated with one or more of the tracked tasks;
a path of one or more of the tracked tasks subject to modification, the modification to create an optimal delivery path in view of the identified statistical deviation; and
selectively execute one or more encoded actions in compliance with the modified path.

8. The computer program product of claim 7, further comprising program code to classify at least one task and one task characteristic corresponding to the identified statistical deviation.

9. The computer program product of claim 8, further comprising program code to train a machine learning model to analyze the classified at least one task and one task characteristic.

10. The computer program product of claim 9, further comprising program code to crowdsource the collected task and task characteristic data, and the machine learning model program code to aggregate the collected task and task characteristic data across a select population, and analyze the classified at least one task and one task characteristic across the aggregated data.

11. The computer program product of claim 10, further comprising program code to employ a Gaussian distribution for the aggregated data and derive a continuous probability distribution model, and the machine learning model to identify an outlier within the distribution model.

12. The computer program product of claim 11, wherein the program code to modify a path of one or more of the tracked tasks includes the machine learning model to create an association between the identified outlier and a corresponding task, and the modification including an action selected from the group consisting of: re-arranging one or more task components, re-assigning the task, and combinations thereof.

13. A computer implemented method, comprising:
collecting and tracking tasks and task characteristics over one or more defined temporal segments;
temporally analyzing one or more data points and corresponding measurements of the collected and tracked tasks and task characteristics, including analyzing task movement;
responsive to identifying a statistical deviation in the analyzed one or more data points, identifying statistically significant data associated with one or more of the tracked tasks;
modifying a path of one or more of the tracked tasks, the modification creating an optimal delivery path in view of the identified statistical deviation; and
selectively executing one or more encoded actions in compliance with the modified path.

14. The method of claim 13, further comprising classifying at least one task and one task characteristic corresponding to the identified statistical deviation.

15. The method of claim 14, further comprising training a machine learning model to analyze the classified at least one task and one task characteristic.

16. The method of claim 15, further comprising crowdsourcing the collected task and task characteristic data, and the machine learning model aggregating the collected task and task characteristic data across a select population, and analyzing the classified at least one task and one task characteristic across the aggregated data.

17. The method of claim 16, further comprising employing a Gaussian distribution for the aggregated data and deriving a continuous probability distribution model, and the machine learning model identifying an outlier within the distribution model.

18. The method of claim 17, wherein modifying a path of one or more of the tracked tasks includes the machine learning model creating an association between the identified outlier and a corresponding task, and the modifying including an action selected from the group consisting of: re-arranging one or more task components, re-assigning the task, and combinations thereof.
